(19) United States
(12) Patent Application Publication
(10) Pub. No.: US 2017/0088150 A1
(43) Pub. Date: Mar. 30, 2017

(54) BRAKE TROLLEY AND A BRAKE SYSTEM FOR A CONTINUOUS BELAY SYSTEM

(71) Applicant: Kanopeo GmbH, Basel (CH)

(72) Inventor: Jaques CHRISTINET, Zermatt (CH)

(21) Appl. No.: 14/863,683

(22) Filed: Sep. 24, 2015

(51) Int. Cl. B61H 9/02; B60T 7/16

(52) U.S. Cl. CPC B61H 9/02; B60T 7/16

(57) ABSTRACT

A brake trolley (28) for a continuous belay system comprising a body portion (29) and a stopper (42) connected to the body portion and configured to abut against the pulley. The body portion comprising a slideable support tube (30) configured to be mounted around a riding cable (2), a connection flange (34) attached to a first end of the slideable support tube and configured to be attached to the traction member, and a spacer plate portion (38) attached to the second end of the slideable support tube and interconnecting the stopper to the slideable support tube. The connection flange and the spacer plate portion both extend in transverse directions in relation to an axial direction (A) of the slideable support tube, and the thickness (w1, w2) of the spacer plate portion and the connection flange are smaller than an external diameter (D) of the slideable support tube.

### FIELD OF THE INVENTION

The present invention relates to a braking system for a suspended continuous belay system. More particularly, the present invention relates to a brake trolley arranged to slow down the travel speed of a pulley riding on a riding cable.

### BACKGROUND

Suspended belay systems are widely used for providing security against falls. Belay systems comprise a riding cable to which a user can safely connect himself with a pulley and a harness. Solutions for continuous security and safe transporting of people are often required in sports and leisure applications such as adventure and panorama trails. However, belay systems can also be used when performing work at high heights.

In continuous belay systems with a trail stretching over a longer distance, it is common that portions of the trail have a steep decent through which a user will increase his speed considerably. It is therefore necessary to either be able to slow down the speed of the user when he is passing through these areas, or at least slow his speed down before he arrives at a critical point, such as a connection point of the riding cable to a fixed structure. It is known to arrange a moveable brake trolley at the end of a trail such that the trolley can engage with the pulley to slow it down. Typically a magnetic brake is connected to the brake trolley such that it can exercise resistance on the pulley. After the engagement of the brake, the pulley needs to be disconnected from the brake and the riding cable.

A problem with present brake systems for suspended continuous belay system is a reduced security when for the user when disconnecting the brake from the riding cable.

### SUMMARY OF THE INVENTION

In view of the above mentioned drawback of the prior art, it is an object of the present invention to provide a brake trolley which can be arranged at any portion of a trail and through which a user can pass safely and continue traveling along the trail.

It is advantageous to provide a brake trolley which is easy to mount.

It is advantageous to provide a brake trolley that is economical to produce. It is advantageous to provide a brake trolley that is durable and easy to maintain.

Disclosed herein and according to a first aspect of the invention is a brake trolley for a continuous belay system comprising a riding cable, a movably guided pulley riding on the riding cable and a traction member, the brake trolley comprising a body portion and a stopper connected to the body portion and configured to abut against the pulley, wherein the body portion comprises a slideable support tube configured to be mounted around the riding cable, said slideable support tube having an external diameter, a first end and a second end and an axial direction coinciding with an axial direction of the riding cable, a connection flange attached to the first end of the slideable support tube and configured to be attached to the traction member, and a spacer plate portion attached to the second end of the slideable support tube and interconnecting the stopper to the slideable support tube, wherein the connection flange and the spacer plate portion both extend in transverse directions in relation to the axial direction of the slideable support tube, and wherein the thickness of the spacer plate portion and the thickness of the attachment element in the axial direction of the slideable support tube are both smaller than the external diameter of the slideable support tube.

Advantageously, the connection flange and the spacer plate are extending in different directions.

In an embodiment, the connection flange is located and extending vertically above the slideable support tube and the spacer plate is located and extending vertically below the slideable support tube.

The connection flange may further comprise an attachment element for connection with the traction member. Advantageously, the attachment element is a hole.

Advantageously, the brake trolley further comprises a first spacer tube and a second spacer tube arranged inside the slideable support tube at the first end and the second end.

In an exemplary embodiment, the stopper is removeably attached to the brake trolley.

In an embodiment, the end of the spacer plate portion is outwardly bent in perpendicular to the axial direction of the slideable support tube, such that a mounting portion for the stopper is created.

Preferably, the body is formed from a first half-shell and a second half-shell, each half shell having a first mating ridge and a second mating ridge such that the slideably support tube is connected at two positions in the circumferential surface of the tube.

Advantageously, the first mating ridge and the second mating ridge is a dented surface, preferably a dovetail surface.

In an embodiment, each half shell is formed in a single piece of material. The shell may be formed from punching of a single sheet material. Alternatively, the shell may be casted.

In an embodiment, the connection flange and the spacer plate are provided with apertures for receiving fasteners.

Also disclosed herein and according to a second aspect of the invention is a brake system for a continuous belay system comprising a riding cable, a tension member, a slideably moveable pulley and a slideably mounted brake trolley, the pulley having a housing with a slotted opening and cable passage both extending in the longitudinal direction of the riding cable, and wherein the width of the slotted opening is wider than the thickness of the connection flange and the thickness of the spacer plate portion in the axial direction of the slideable support tube.

Disclosed herein and according to a third aspect of the invention is a method for mounting a brake trolley around a riding cable, the brake trolley comprising a body having a first half shell and a second half shell, the method comprising the steps of:
Holding and positioning the first a first half-shell and the second half-shell on opposite sides of the riding cable,
Engaging a first ridge of the first half-shell with a first mating ridge of the second half-shell,
Engaging a second ridge of the first half-shell with a second mating ridge of the second half-shell,
Inserting a first spacer tube into a first end of the slideable support tube,
Inserting a second spacer tube into a second end of the slideable support tube,
Inserting at least one fastener through an attachment element at a first end of the brake trolley,
Inserting at least one fastener through a spacer plate portion at the second end of the brake trolley, and
Mounting a stopper at the second end of the mounting portion.

### BRIEF DESCRIPTION OF THE DRAWINGS

The invention will now be described in more detail with reference to the accompanying drawings, which by way of example illustrate the present invention and in which:

FIG. 1a is a schematic view of an exemplary embodiment of a belay system according to the present invention,

FIG. 1b is a schematic view of another exemplary embodiment of a belay system according to the present invention,

FIGS. 2a, 2b and 2d are schematic perspective views of an exemplary pulley suitable to be used together with the brake trolley according to the present invention,

FIG. 2c is a schematic perspective view of the pulley of FIG. 2a when the pulley is passing over a bracket without disconnection,

FIG. 3a is a schematic perspective view of a brake trolley according to an embodiment of the present invention,

FIG. 3b is a schematic perspective view of a brake trolley of the present invention when used together with a brake pulley as illustrated in FIG. 2b,

FIGS. 4a and 4b are schematic side views of a brake trolley according to an embodiment of the present invention and illustrate how the pulley can be moved over the brake trolley,

FIG. 5a is a side view of a body portion of the brake trolley,

FIG. 5b is a top view of the body portion of the brake trolley as illustrated in FIG. 5a, and FIGS. 6a and 6b are schematic perspective views illustrating how the present brake trolley can be mounted around a riding cable.

### DETAILED DESCRIPTION

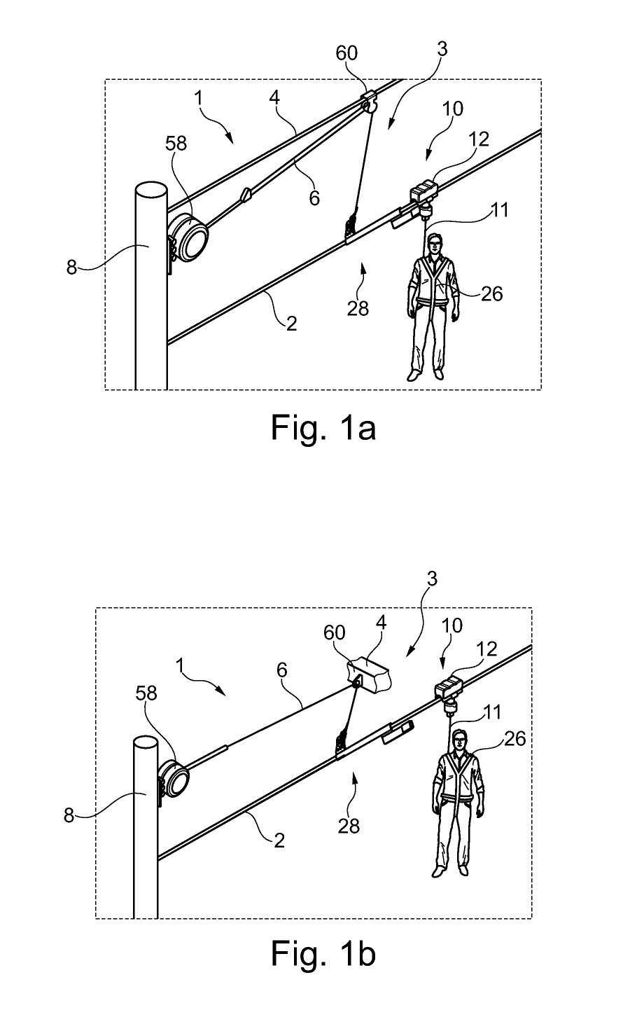

Referring to the figures, and in particular to FIGS. 1a and 1b, a belay system 1 according to the present invention is illustrated. The belay system 1 comprises a fixed structure 8 to which a riding cable 2 is connected, a slideably moveably pulley 10 riding on the riding cable 2 and a harness 26 configured to be worn by a person and attached to the pulley by a personal safety line 11. The riding cable 2 is extending along a path which is the distance from a starting point to a finish point.

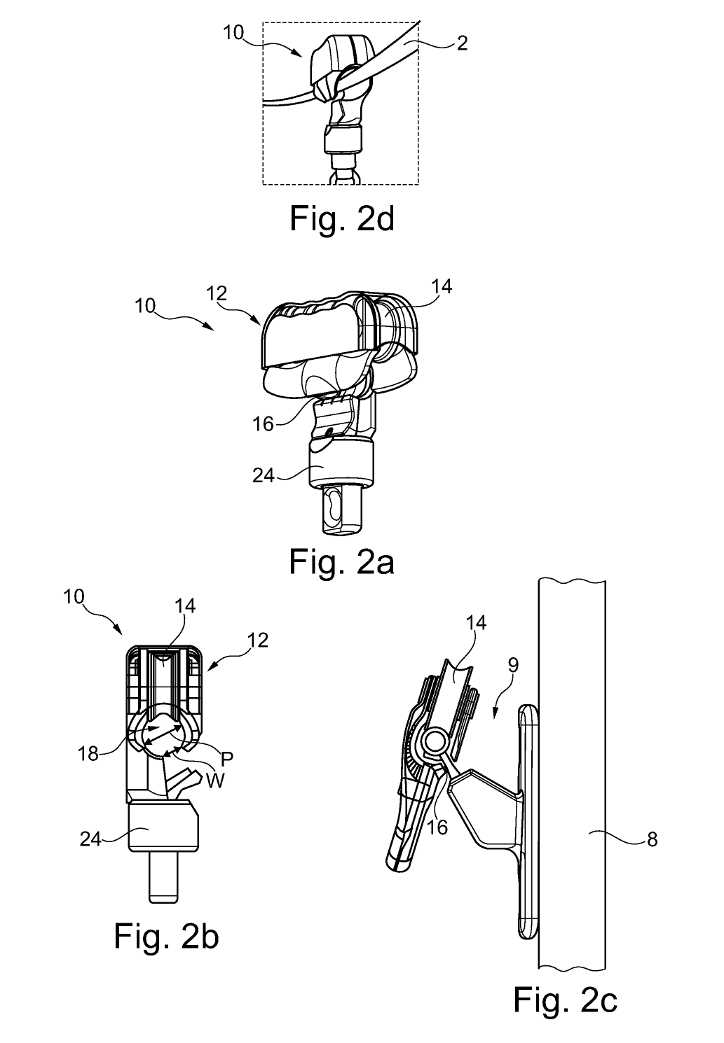

The pulley 10 to be used in the present belay system may for instance be a pulley 10 which is commercially available from Kanopeo under the name Saferoller®. As best seen in FIGS. 2a-2d, the pulley 10 has an external housing 12 with a slotted opening 16, rollers 14, a cable passage 18 and an anchor portion 24 attached to the external housing 12. Inside the external housing 12 of the pulley, the rollers 14 are arranged vertically above the riding cable 2, such that the pulley 10 can slideably move along the riding cable 2 with low friction. As illustrated in FIG. 2c, the slotted opening 16 makes it possible for the pulley to slide over connection points where brackets 9 connect the riding cable 2 to the fixed structure 8. Typically, the fixed structure 8 may comprise vertical pillars, but the brackets 9 may also connect the riding cable 2 directly to an existing structure such as e.g. a rock wall.

As illustrated in FIGS. 1a and 1b, the present belay system further comprises a brake system 3 configured to slow down the movement of the pulley 10 in relation to the riding cable 2. Typically, the brake system 3 is arranged on at least one portion along the path, such as a portion with steep decent, at a finish point of the path or where there is a need to reduce the travel speed of the user.

The brake system 3 comprises a slideably moveable brake trolley 28, which when located in front of the pulley 10 in the direction of travel, exercises a braking force on the pulley 10. The brake trolley 28 is connected to a traction member 6 which is configured to absorb part of the kinematic energy of the pulley 10 such that it can be slowed down. The traction member 6 may for instance be an elastic member such as a traction spring, connected directly to the brake trolley 28, or indirectly connected to the brake trolley by a cable. Additionally or alternatively, the traction member can be a damper. The traction member 6 is connected to an anchor point 60, which determines the point of engagement between the pulley 10 and the brake trolley 28. The anchor point 60 needs to be attached to a fixed element 4. As illustrated in FIG. 1a, the fixed element 4 may be a braking support cable 4 arranged above the riding cable. Alternatively, as illustrated in FIG. 1b, the fixed element 4 may be a fixed external structure such as a pillar, a tree or a rock surface.

In the example illustrated in FIGS. 1a and 1b, the traction member is a cable 6 connected to a brake unit 58. The brake unit 58 can be a magnetic brake which counteracts the movement of the brake trolley 28 in the direction of travel by exercising a resistance thereon. In this embodiment, the traction member 6 is a braking cable 6. The braking cable 6 is wounded on a spool within the brake unit 58, such that it can be unwound against the kinematic force from the brake trolley 28. For instance the brake unit 58 can be a zip-line brake from the company Zip-stop. The anchor point 60 can be an eye through which the braking cable 6 can pass.

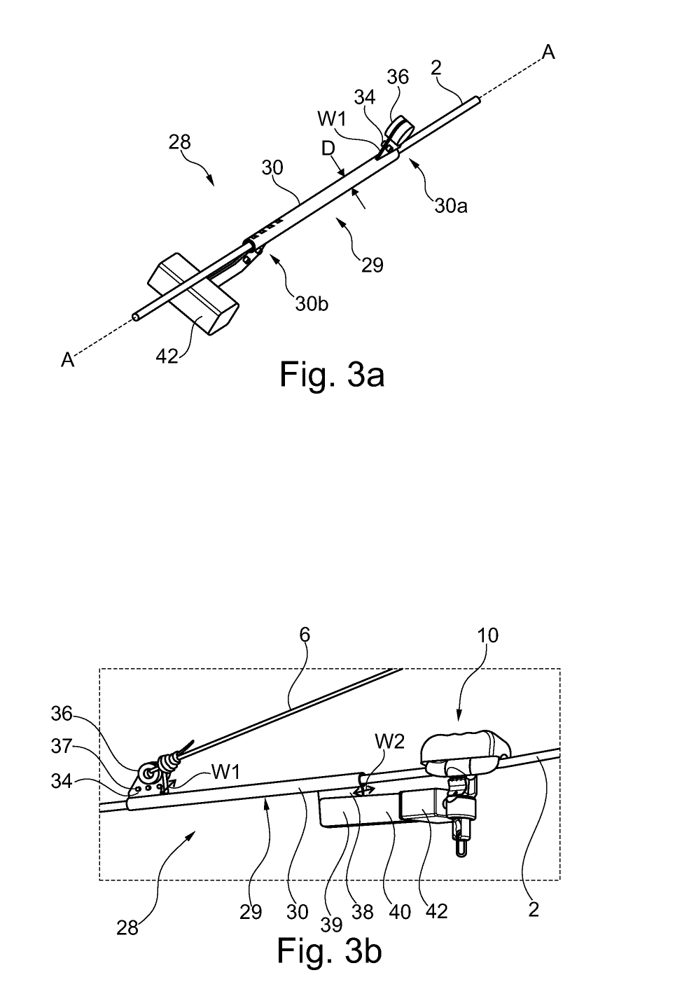

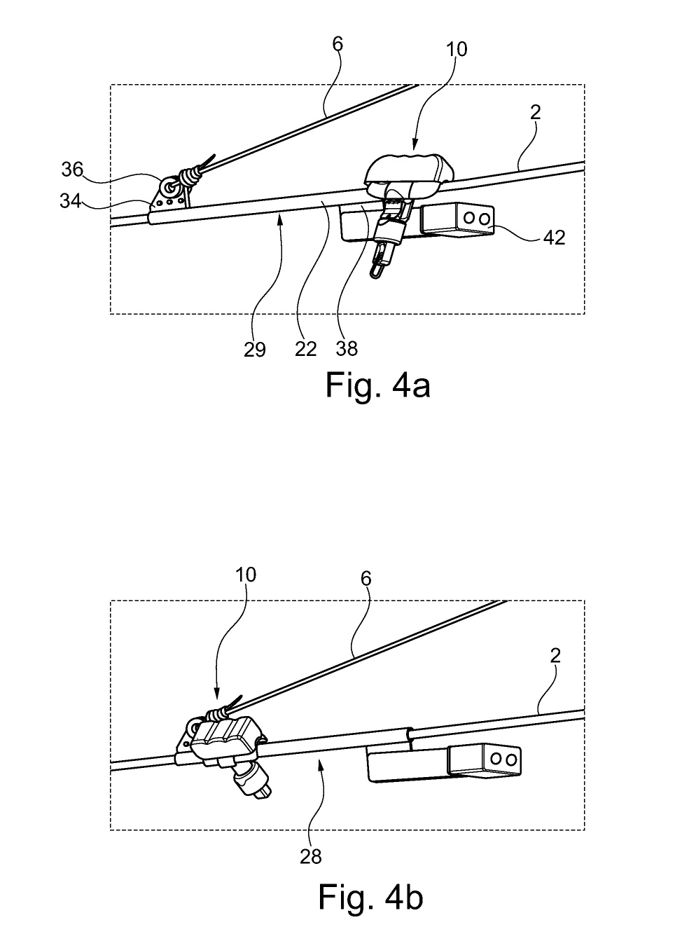

As best seen in FIGS. 3a and 3b the brake trolley 28 comprises a body portion 29 and a stopper 42. The body portion 29 comprises a slideable support tube 30 configured to be mounted around the riding cable 2. The slideable support tube has a first end 30a and a second end 30b, the first end 30a having a connection flange 34 for a traction member 6. The stopper 42 is connected to the second end 30b of the slideable support tube 30 which is configured for engagement with the pulley 10. The stopper 42 is preferably of an elastomeric material such that when the pulley 10 engages with the stopper, it prevents the pulley 10 from getting scratched, dented or damaged by the force of impact.

The connection flange 34 has an attachment element 36 to which the brake trolley 28 can be connected to the traction member 6. The connection flange 34 has a thickness W1 which is inferior to the width W of the slotted opening of the brake trolley 28.

The stopper is connected to the slideable support tube 30 by a spacer plate portion 38 and a connecting piece 40. The spacer plate portion 38 has a thickness W2 which is inferior to the external diameter D of the slideable support tube 30.

As best seen in FIG. 3b, both the thicknesses w1 of the connection flange 34, the thickness W2 of the spacer plate portion 38 are smaller than the width of the W of the slotted opening 16 of the pulley 10. Additionally, the outer diameter D of the slideable support tube 30 is smaller than the diameter P of the cable passage 18 in the pulley 10. Consequently, the pulley 10 is configured to pass over the brake trolley 28 when the connection flange 34 and spacer plate portion 38 are aligned with the slotted opening 16 of the pulley 10.

Now referring to FIGS. 6a and 6b, which illustrate the assembly of the body portion 29. The body portion 29 comprises a first half-shell 44 and a second half-shell 48. Advantageously, the first half-shell 44 and the second half-shell 48 can be formed in one piece. Forming the half-shells in one-piece can be done by for instance bending or stamping of sheet metal. Alternatively, the half-shells can be produced from die casting. However, it is also possible that parts of the body 29 are assembled together by e.g. welding or riveting.

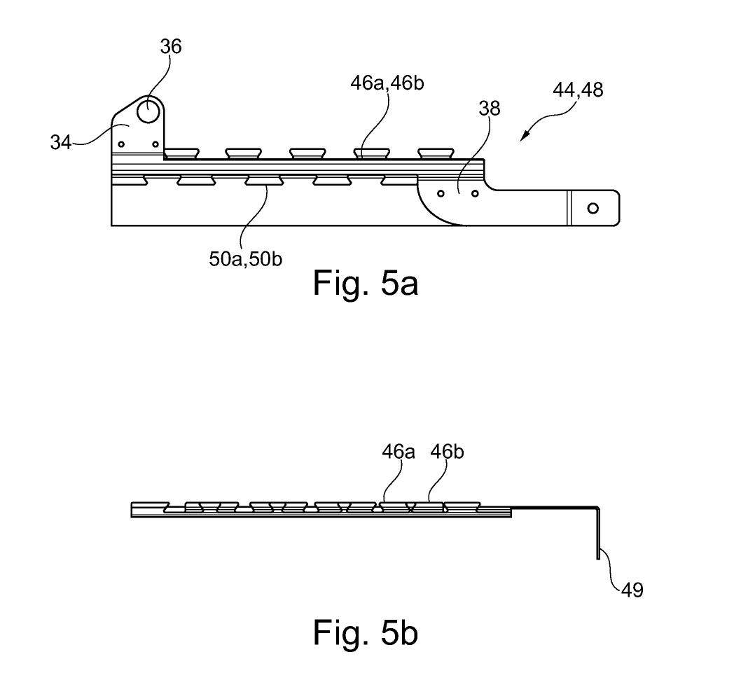

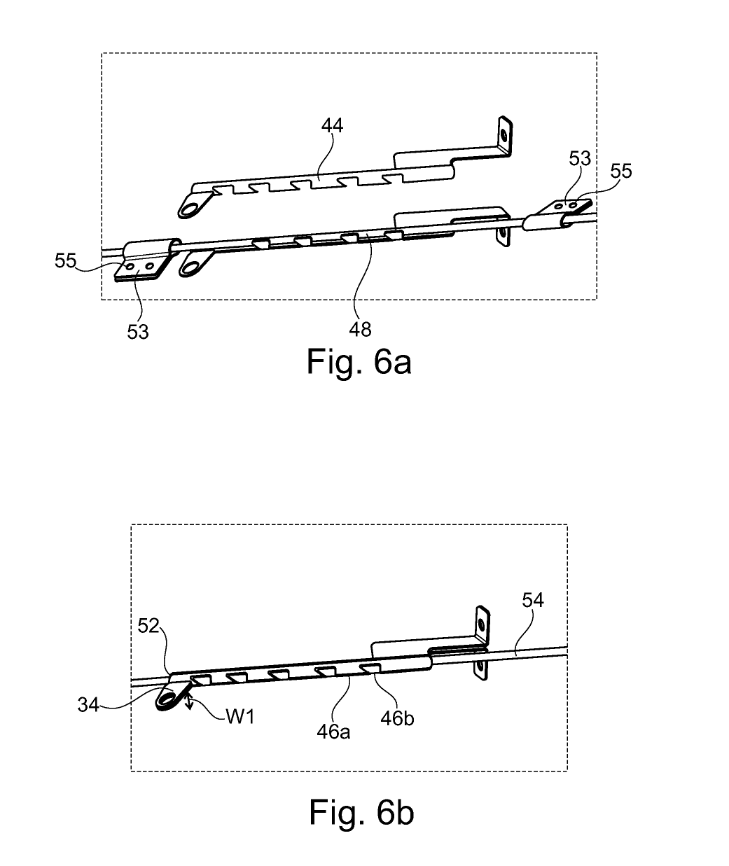

Preferably, as best seen in FIGS. 5a and 5b, each half shell 44, 48 has a first mating ridge 46a, 46b and a second mating ridge 50a, 50b such that the slideably support tube 30 can be connected at two positions in the circumferential surface of the slideably support tube. The mating ridges 46a, 46b, 50a, 50b enable a tool-less mechanical connection between the first half-shell 44 and the second half-shell 48. In other words, the first half shell 44 has a first mating ridge 46a configured to engage with a first mating ridge 46b the second half shell 48, and the first half shell 44 has a second mating ridge 50a configured to engage with a second mating ridge 50b of the second half shell 48. In the embodiment illustrated in FIGS. 5a and 5b, the first engaging surface and the second engaging surface are arranged such that the engagement of the half shells is done on the uppermost and lowermost horizontal surfaces of the slideable support tube 30.

The mating ridges 46a, 46b, 50a, 50b may advantageously have a toothened shape, such as preferably a dovetailed shape. Alternatively, the mating ridges 46a, 46b, 50a, 50b can be formed by a protruding part on one half shell received inside a slot of the other half shell.

A first spacer tube 52 and second spacer tube 54 may be inserted into the slideable support tube 30 at the first end 30a and the second end 30b of the slideable support tube 30. The first spacer tube 52 and the second spacer tube 54 ensure that the slideable support tube 30 is not clamped around the riding cable 2 and that during use, the first spacer tube 52 and the second spacer tube 54 are positioned closer to the riding cable than the body portion 29, whereby the first spacer tube 52 and the second spacer tube 54 protect the slideable support tube 30 from internal wear. The first spacer tube 52 and the second spacer tube 54 can also be easily replaced if needed without having to change the entire brake trolley 28.

Preferably, the spacer tubes 52, 54 have an open portion in the longitudinal direction, such that the spacer tubes can be clipped over the riding cable in its longitudinal direction. Additionally, as illustrated in FIG. 6b, the spacer tubes 52, 54 may have two extending flanges 55 with apertures 53 configured to receive fasteners such that the spacer tubes can be fixedly attached to the spacer plate portion 38 and the connection flange 34.

The first half-shell 44 and a second half-shell 48 may be fixedly connected to each other by fasteners which traverse the connecting piece 40 and the connection flange 34. The distal end of the connecting piece 40 is bent such that a mounting surface 49 is created which extends in perpendicular to the axial direction of the slideable support tube 30. The stopper 42 can be attached to the mounting surface 49 by a e.g. a fastener or an adhesive.

When the brake trolley 28 is to be mounted around a riding cable 2, the first a first half-shell 44 and the second half-shell 48 are held and positioned on opposite sides of the riding cable 2, whereafter the mating ridge 46a of the first half-shell 44 is aligned with the mating ridge 46b of the second half-shell 48, pressure is applied until the mating ridges 46a, 46b clip together. The second mating ridges 50a, 50b are mounted in the same manner as the first mating ridges 46a, 46b. Optionally, a first spacer tube 52 is inserted into a first end 30a of the slideable support tube 30 and a second spacer tube 54 is inserted into a second end 30b of the slideable support tube 30. Thereafter, at least one fastener 37 is inserted through the attachment element 36 at the first end of the body portion 29, and at least one fastener 39 is inserted through a spacer plate portion 38 at the second end 30b of the brake trolley 29. The stopper 42 is thereafter mounted at a mounting portion (49) at the second end 30b of the slideable support tube 30.

The skilled person will realize that the present invention by no means is limited to the described exemplary embodiments. While the invention has been illustrated in detail in the drawings and in the foregoing description, such illustration and description is considered to be illustrative or exemplary and not restrictive; the invention is not limited to the disclosed embodiments.

### LIST OF REFERENCES IN THE FIGURES

(Continuous) Belay system 1
   Riding cable 2
   Fixed structure (beams) 8
   Connection points 7
      Brackets 9
   Personal safety line 10
   Pulley 10
      Housing 12
      Roller 14
      Slotted opening 16
         Width W
      Cable passage 18
         Width P
      Anchor portion 24
   Harness 26
   Brake system 3
      Braking support cable 4
      Braking cable 6
      Brake trolley 28
         Body portion 29
            Slidable support tube 30
            First end 30a
            Second end 30b
            Diameter D
            Axial extension A
            Flange extension (enables pulley to pass through the brake) 32
            Connection flange 34
            Width W1
            Attachment element (opening) 36
            Fastener 37
            Spacer plate portion 38
            Width W2
            Fastener 39
            Connecting piece 40
            Mounting portion 49
         Stopper 42
         First half shell 44
            First engaging surface (dovetail) 46
         Second half shell 48
            Second engaging surface (dovetail) 50
         First spacer tube 52
         Second spacer tube 54
         Fastener 56
      Brake (Magnetic brake) 58
      Anchor point 60

1. A brake trolley for a continuous belay system comprising a riding cable, a movably guided pulley riding on the riding cable and a traction member,
the brake trolley comprising a body portion and a stopper connected to the body portion and configured to abut against the pulley, wherein the body portion comprises a slideable support tube configured to be mounted around the riding cable, said slideable support tube having an external diameter, a first end and a second end and an axial direction coinciding with an axial direction of the riding cable, a connection flange attached to the first end of the slideable support tube and configured to be attached to the traction member, and a spacer plate portion attached to the second end of the slideable support tube and interconnecting the stopper to the slideable support tube, wherein the connection flange and the spacer plate portion both extend in transverse directions in relation to the axial direction of the slideable support tube, and wherein the thickness of the connection flange and the thickness of the spacer plate portion in the axial direction of the slideable support tube are both smaller than the external diameter of the slideable support tube.

2. The brake trolley according to claim 1, wherein the connection flange and the spacer plate extend in different directions.

3. The brake trolley according to claim 2, wherein the connection flange is located and extends vertically above the slideable support tube and the spacer plate is located and extends vertically below the slideable support tube.

4. The brake trolley according to claim 1, wherein the connection flange further comprises an attachment element for connection with the traction member.

5. The brake trolley according to claim 1, wherein the brake trolley further comprises a first spacer tube and a second spacer tube arranged inside the slideable support tube at the first end and the second end.

6. The brake trolley according to claim 1, wherein the stopper is removeably attached to the brake trolley.

7. The brake trolley according to claim 1, wherein the end of the spacer plate portion is outwardly bent in perpendicular to the axial direction of the slideable support tube, such that a mounting portion for the stopper is created.

8. The brake trolley according to claim 1, wherein the body is formed from a first half-shell and a second half-shell, each half shell having a first mating ridge and a second mating ridge such that the slideably support tube is connected at two positions in the circumferential surface of the tube.

9. The brake trolley according to claim 8, wherein the first mating ridge and the second mating ridge is a dented surface, preferably a dovetail surface.

10. The brake trolley according to claim 1, wherein each half shell is formed in a single piece of material.

11. The brake trolley according to claim 10, wherein the shell is a part formed from a single stamped sheet material.

12. The brake trolley according to claim 10, wherein the shell is a cast part.

13. The brake trolley according to claim 1, wherein the connection flange and the spacer plate are provided with apertures for receiving fasteners.

14. A brake system for a continuous belay system comprising a riding cable, a tension member , a slideably moveable pulley and a slideably mounted brake trolley according to claim 1, the pulley having a housing with a slotted opening and cable passage both extending in the longitudinal direction of the riding cable, and wherein the width of the slotted opening is larger than the thickness of the connection flange and the thickness of the spacer plate portion in the axial direction of the slideable support tube.

15. A method for mounting a brake trolley around a riding cable, the brake trolley comprising a body having a first half shell and a second half shell, the method comprising the steps of:
Holding and positioning the first a first half-shell and the second half-shell on opposite sides of the riding cable,
Engaging a first ridge of the first half-shell with a first mating ridge of the second half-shell,
Engaging a second ridge of the first half-shell with a second mating ridge of the second half-shell,
Inserting a first spacer tube into a first end of the slideable support tube
Inserting a second spacer tube into a second end of the slideable support tube
Inserting at least one fastener through an connection flange at a first end of the brake trolley,
Inserting at least one fastener through a spacer plate portion at the second end of the brake trolley, and
Mounting a stopper at the second end of the mounting portion.
